(19) United States
(12) Patent Application Publication
(10) Pub. No.: US 2009/0311542 A1
(43) Pub. Date: Dec. 17, 2009

(54) METAL SHELL WITH PRINTING PATTERNS FOR AN ELECTRIC APPLICATION AND METHOD FOR FORMING THE SAME

(76) Inventors: Da-Sen Lin, Taichung (TW); Chien-Liang Lin, Taichung (TW)

Correspondence Address: PAI PATENT & TRADEMARK LAW FIRM, 1001 FOURTH AVENUE, SUITE 3200, SEATTLE, WA, 98154, US

(21) Appl. No.: 12/140,275

(22) Filed: Jun. 17, 2008

(51) Int. Cl. B32B 15/04; C25D 5/02

(52) U.S. Cl. 428/457; 205/118

(57) ABSTRACT

A metal shell with printing patterns has a metal body, a printing layer and an electroplating layer. The metal body has an outer surface and an area. The printing layer is attached to the outer surface of the metal body to form the printing patterns and has an area smaller than that of the metal body. The electroplating layer is attached to the outer surface of the metal body at a region beside the printing layer.

### BACKGROUND OF THE INVENTION

1. Field of the Invention

The present invention relates to a shell, and more particularly to a metal shell with printing patterns for an electric application and a method for forming the same.

2. Description of Related Art

An electric application, such as an electric pot or microwave oven always has patterns for trademarks or decorations to decorate or distinguish the application. To form patterns on an electric application, an adhesive paper/film with patterns is used to attach to a shell of the electric application. However, the conventional way of forming patterns on the electric application with adhesive paper has the following drawbacks.

1. When the adhesive paper cannot be attached flatly onto the outer surface of the shell, bubbles easily occur between the outer surface of the shell and the adhesive paper. However, the bubbles cause the patterns not smooth and unaesthetic to the appearance of the electric application.

2. To attach the adhesive paper to a smooth outer surface of the shell is difficult, and the adhesive paper easily becomes warped due to moisture or temperature change. This also causes the appearance of the metal shell unaesthetic.

With reference to FIG. 9, another way of forming patterns on a shell of an electric application is printing patterns onto the shell. The shell of an electric application always has an electroplating layer formed on the shell, and a printing layer is formed on the electroplating layer with a printing process. However, the electroplating layer is very smooth, so the printing layer is difficult to be formed on the smooth electroplating layer and easily falls off from the electroplating layer.

The method for forming patterns on a shell comprises acts of:

a) providing a metal body with an outer surface;

b) printing a printing layer onto the outer surface of the metal body; and

c) electroplating to forming an electroplating layer on the outer surface of the metal body at a region beside the printing layer.

To overcome the shortcomings, the present invention tends to provide a metal shell for an electric application to mitigate or obviate the aforementioned problems.

### SUMMARY OF THE INVENTION

The main objective of the invention is to provide a metal shell with printing patterns for an electric application and a method for forming the same. The metal shell has a metal body, a printing layer and an electroplating layer. The metal body has an outer surface and an area. The printing layer is attached to the outer surface of the metal body and has an area smaller than that of the metal body. The electroplating layer is attached to the outer surface of the metal body at a region beside the printing layer.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of an electric application with a metal shell in accordance with the present invention;

FIG. 2 is an enlarged cross sectional side view of a first embodiment of a metal shell in accordance with the present invention;

FIG. 3 is an enlarged cross sectional side view of a second embodiment of a metal shell in accordance with the present invention;

FIG. 4 is an enlarged cross sectional side view of a third embodiment of a metal shell in accordance with the present invention;

FIG. 5 is a block diagram of a method for forming a metal shell in accordance with the present invention;

FIG. 6 is operational cross sectional side views showing the method for forming the metal shell in FIG. 5;

FIG. 7 is a perspective view of an application with another embodiment of a metal shell in accordance with the present invention;

FIG. 8 is operational cross sectional side views showing the method for forming the metal shell in FIG. 7; and

FIG. 9 is a cross sectional side view of a conventional shell with printing patterns for an electric application in accordance with the prior art.

### DETAILED DESCRIPTION OF PREFERRED EMBODIMENT

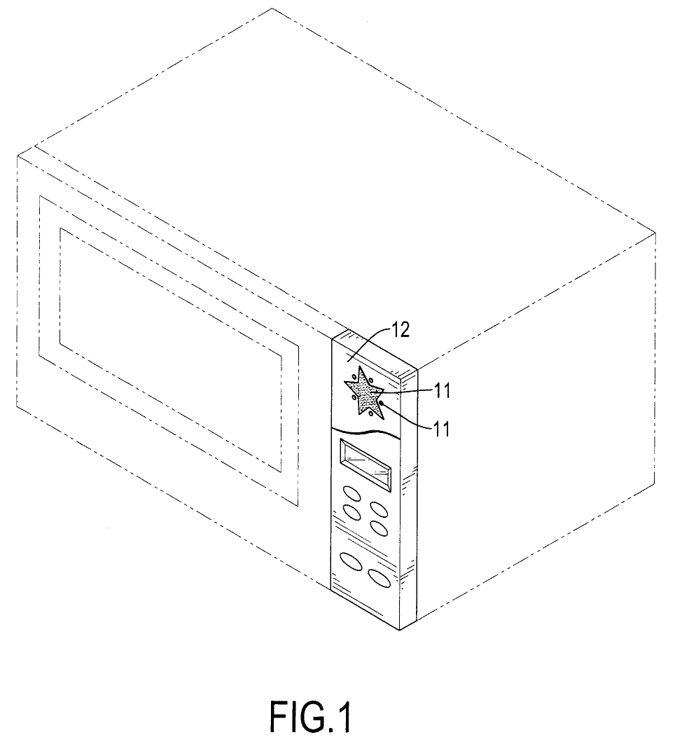

With reference to FIGS. 1 to 4, a metal shell for an electric application in accordance with the present invention comprises a metal body (10,10A,10B), a printing layer (11,11A,11B) and an electroplating layer (12,12A,12B).

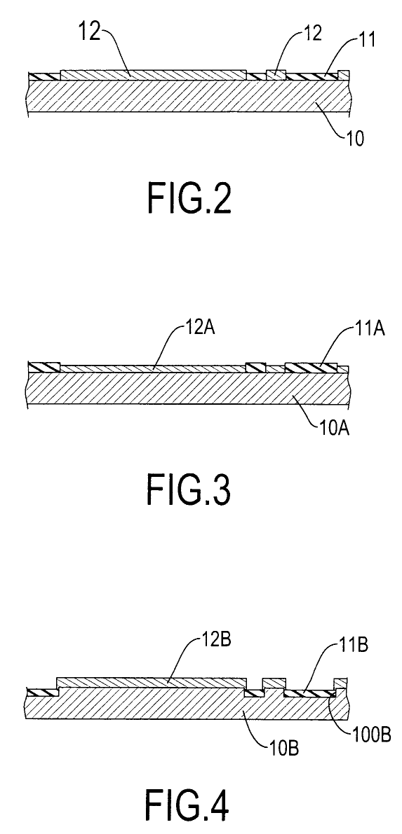

The metal body (10,10A,10B) is made of metal and has an outer surface and an area. The printing layer (11,11A,11B) is attached to the outer surface of the metal body (10,10A,10B) with a printing process in a single color or multiple colors and has an area smaller than that of the metal body (10,10A,10B). The electroplating layer (12,12A,12B) is attached to the outer surface of the metal body (10,10A,10B) with a plating process and at a region beside the printing layer (11,11A,11B). With reference to FIGS. 2 and 3, the thickness of electroplating layer (12,12A) may be equal to, larger or smaller than that of the printing layer (11,11A). In addition, with reference to FIG. 4, the metal body (10B) may further have at least one cavity (100B) defined in the outer surface, and the printing layer (11B) is mounted in the cavity (100B) in the metal body (10B).

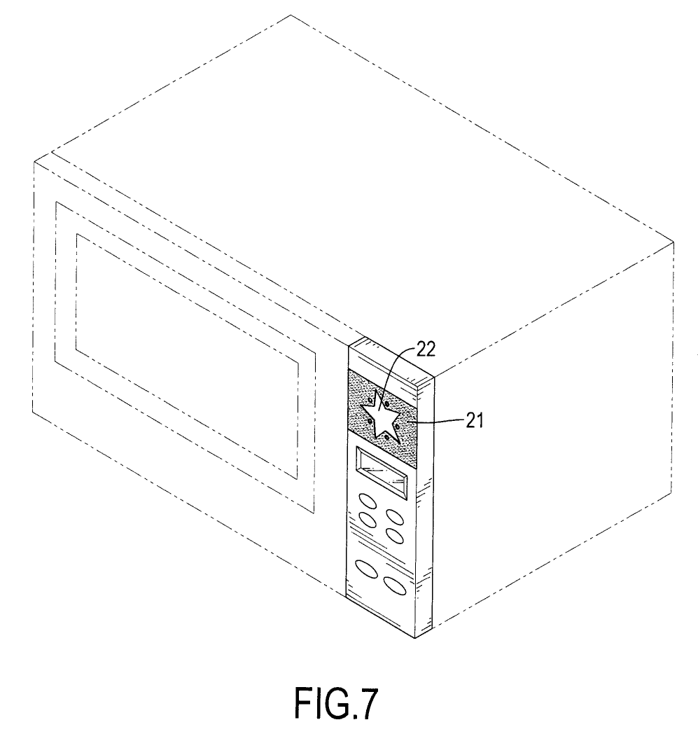

In an embodiment as show in FIG. 1, the electroplating layer (12,12A,12B) is mounted around the printing layer (11,11A,11B). In an alternative embodiment as shown in FIG. 7, the printing layer (21) on the metal body is mounted around the electroplating layer (22).

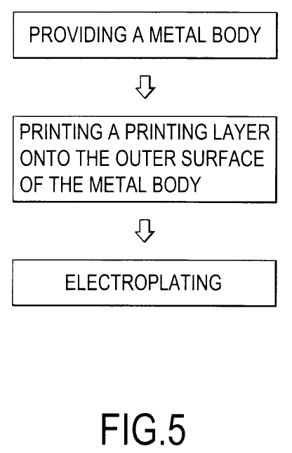

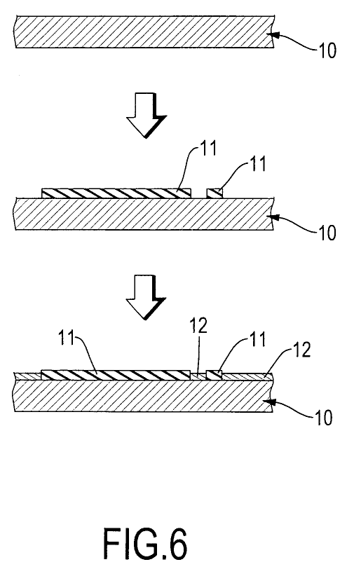

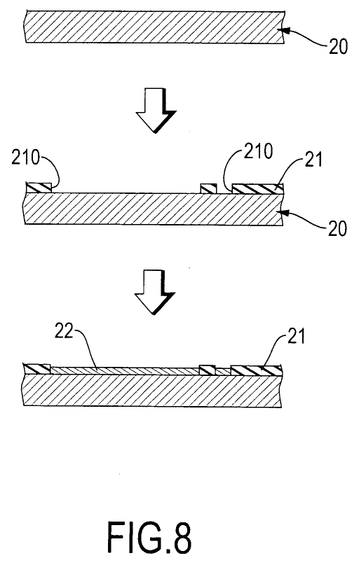

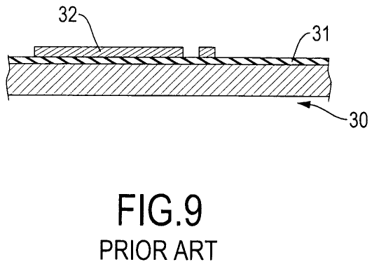

With reference to FIGS. 5, 6 and 8, a method for forming a metal shell in accordance with the present invention comprises acts of:

a) Providing a metal body (10,20) with an outer surface.

b) Printing a printing layer (11,21) onto the outer surface of the metal body (10,20). The printing layer (11,21) is printed onto the outer surface of the metal body (10,20) in a single color or multiple colors to form patterns on the metal body (10,20). Because the metal body (10,20) has a rough surface before an electroplating process is applied, the printing layer (11,21) can be easily and securely formed on the rough outer surface of the metal body (10,20).

c) Electroplating. Forming the electroplating layer (12,22) on the outer surface of the metal body (10,20) with an electroplating process. Because the printing layer (11,21) is isolated, the area of the printing layer (11,21) on the metal body (10,20) can be kept from forming the electroplating layer (12,22). Accordingly, the electroplating layer (12,22) is formed on a region beside the printing layer (11,21).

Because the patterns on the metal shell are constructed by the printing layer (11,21), the patterns can be smoothly and flatly formed on the metal shell to make the appearance of the metal shell aesthetic. The printing layer (11,21) is not easily even impossibly detached from the metal shell, the metal shell with printing patterns is durable. In addition, the thicknesses of the printing and electroplating layers (11,12,21,22) can be controlled to form relief or intaglio patterns on the metal shell, such that the appearance of the metal shell is versatile and aesthetic.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A metal shell for an electric application comprising:
a metal body with an outer surface and an area;
a printing layer attached to the outer surface of the metal body and having an area smaller than that of the metal body; and
an electroplating layer attached to the outer surface of the metal body at a region beside the printing layer.

2. The metal shell as claimed in claim 1, wherein the electroplating layer has a thickness larger than that of the printing layer.

3. The metal shell as claimed in claim 1, wherein the electroplating layer has a thickness smaller than that of the printing layer.

4. The metal shell as claimed in claim 1, wherein the metal body has a cavity defined in the outer surface; and
the printing layer is mounted in the cavity in the metal body.

5. The metal shell as claimed in claim 1, wherein the electroplating layer is mounted around the printing layer.

6. The metal shell as claimed in claim 2, wherein the electroplating layer is mounted around the printing layer.

7. The metal shell as claimed in claim 3, wherein the electroplating layer is mounted around the printing layer.

8. The metal shell as claimed in claim 4, wherein the electroplating layer is mounted around the printing layer.

9. The metal shell as claimed in claim 1, wherein the printing layer is mounted around the electroplating layer.

10. The metal shell as claimed in claim 2, wherein the printing layer is mounted around the electroplating layer.

11. The metal shell as claimed in claim 3, wherein the printing layer is mounted around the electroplating layer.

12. The metal shell as claimed in claim 4, wherein the printing layer is mounted around the electroplating layer.

13. A method for forming patterns on a shell comprising acts of:
a) providing a metal body with an outer surface;
b) printing a printing layer onto the outer surface of the metal body; and
c) electroplating to forming an electroplating layer on the outer surface of the metal body at a region beside the printing layer.
